(19) United States
(12) Patent Application Publication
(10) Pub. No.: US 2009/0135187 A1
(43) Pub. Date: May 28, 2009

(54) SYSTEM AND METHOD FOR DYNAMICALLY GENERATING RESPONSE MOTIONS OF VIRTUAL CHARACTERS IN REAL TIME AND COMPUTER-READABLE RECORDING MEDIUM THEREOF

(75) Inventors: Huai-Che Lee, Taipei County (TW); Wei-Te Lin, Taichung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INSTITUTE FOR INFORMATION INDUSTRY, Taipei (TW)

(21) Appl. No.: 11/960,724

(22) Filed: Dec. 20, 2007

(30) Foreign Application Priority Data
Nov. 28, 2007 (TW) 96145203

(51) Int. Cl. G06T 13/00

(52) U.S. Cl. 345/473

(57) ABSTRACT

A system and a method for dynamically generating response motions of a virtual character in real time and a computer-readable recording medium thereof are provided. The system includes a balance state module, response graph module, and a tracking control module. The balance state module calculates a balance state of the virtual character according to the balance-related information of a character model of the virtual character. The response graph module is coupled to the balance state module for providing a response motion according to the balance state. The tracking control module is coupled to the response graph module for providing a driving information according to the response motion and a body information of the character model. The driving information is used for driving the character model to converge toward the response motion.

### CROSS-REFERENCE TO RELATED APPLICATION

This application claims the priority benefit of Taiwan application serial no. 96145203, filed Nov. 28, 2007. The entirety of the above-mentioned patent application is hereby incorporated by reference herein and made a part of this specification.

### BACKGROUND OF THE INVENTION

1. Field of the Invention

The present invention generally relates to a system and a method for simulating response motions of a virtual character and a recording medium thereof, in particular, to a system and a method for dynamically generating response motions of a virtual character in real time and a recording medium thereof.

2. Description of Related Art

In the interactive environment of a computer game, forces are transmitted through impacts or interactions between different virtual characters or between virtual characters and the surroundings. The effects and subsequent actions of the virtual characters brought by such force transmissions are referred as response motions. The response motions of virtual characters in computer games are usually achieved through pre-recorded responses or physical simulations.

According to the method of pre-recorded responses, a motion database of desired motion segments is established through motion capturing or key-framing. When a response motion is to be presented in a computer game, a motion segment in the motion database is selected and played based on a pre-edited game logic. In this way, the state of a virtual character in a game can be effectively controlled. However, since there is only limited number of motion segments in the motion database, the motion variability of the virtual character depends completely on the number of motion segments stored in the motion database, and accordingly, transitions between different motion segments may look very unnatural. If the number of motion segments is increased in order to increase the smoothness and variability of the motions of the virtual character, the requirement to memory space is increased and additional fabrication and management costs are required.

According to the method of physical simulation, a virtual character is defined as a physical model, namely, a character model, and response motions of the virtual character are produced through a physical simulation process. For example, a response motion conforming to physical effects can be dynamically produced according to physical parameters such as the strength and direction of an impact. The response motion presents good physical aliveness since it is calculated in a physical environment. However, even though foregoing method can produce smooth motions and does not require any motion sequence, it is difficult to keep balance for a biped model, not to mention achieving artistically fine motions, since all the motions in a physical environment have to be produced through acting forces or moments. Moreover, it is very complicated to set parameters for a virtual character during a physical simulation process, and a lot of calculations are required by fine physical simulations. Accordingly, the real-time calculation required by a computer game is difficult to be achieved through physical simulation.

### SUMMARY OF THE INVENTION

Accordingly, the present invention is directed to a system and a method for dynamically generating response motions of a virtual character in real time and a recording medium thereof. The present invention integrates the techniques of pre-recorded response and physical simulation therefore has the advantages of both the two.

The present invention provides a system for dynamically generating response motions of a virtual character in real time. The system includes a balance state module, a response graph module, and a tracking control module. The balance state module calculates a balance state of the virtual character according to the balance-related information of a character model of the virtual character. The response graph module is coupled to the balance state module for providing a response motion according to the balance state. The tracking control module is coupled to the response graph module for providing a driving information according to the response motion and a body information of the character model. The driving information is used for driving the character model to converge toward the response motion.

According to an embodiment of the present invention, the balance-related information includes at least one of the mass, position, orientation, and speed of each body segment of the character model.

According to an embodiment of the present invention, the balance state module defines a plurality of balance state areas on the ground according to the feet positions of the character model, calculates the position of the center of mass (CoM) of the character model, and determines the balance state according to the projection of the CoM on the ground in relation to the balance state areas.

According to an embodiment of the present invention, the balance state includes at least one of the pose, the orientation, the unbalanced degree, and the unbalanced direction of the virtual character.

According to an embodiment of the present invention, the response graph module includes a state machine. The state machine is corresponding to a response graph. The response graph includes a plurality of response styles. Each of the response styles includes a plurality of response motions and is corresponding to one of a plurality of states of the state machine. The response graph module determines the response style of the virtual character according to the balance state and selects one of the response motions of the response style according to the balance state and provides the selected response motion to the tracking control module.

According to an embodiment of the present invention, the balance state includes two items. The response graph module determines the response style according to the first item and selects the response motion according to the second item.

According to an embodiment of the present invention, the system for dynamically generating response motions of a virtual character in real time further includes a physical environment module. The physical environment module is coupled to the balance state module for providing an external force information to the balance state module. The balance state module calculates the balance state according to the balance-related information and the external force information.

According to an embodiment of the present invention, the external force information includes an impact and/or the gravity received by the virtual character.

The present invention further provides a method for dynamically generating response motions of a virtual character in real time. The method includes following steps. First, a balance state of the virtual character is calculated according to the balance-related information of a character model of the virtual character. Then, a response motion is provided according to the balance state. After that, a driving information is provided according to the response motion and the body information of the character model, wherein the driving information is used for driving the character model to converge toward the response motion.

The present invention also provides a computer-readable recording medium for storing a program. The program executes a method for dynamically generating response motions of a virtual character in real time. The steps of the method have been described above therefore will not be described herein.

In the present invention, the physical responses to impacts of a virtual character are simulated through the method of physical simulation, and response motions of the virtual character are provided through the method of pre-recorded responses. In the present invention, the response motion of a virtual character is selected from a pre-established response graph according to the balance state of the virtual character. Thereby, the present invention has the advantages of both the method of pre-recorded response and the method of physical simulation and can present lively and smooth character motions conforming to physical effects. Moreover, in the present invention, real-time calculation can be achieved with less memory space.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A illustrates a pre-recorded response motion according to an embodiment of the present invention.

FIGS. 1B˜1D illustrate pre-recorded motions with physical simulation according to an embodiment of the present invention.

FIG. 2 is a block diagram of a system for dynamically generating response motions of a virtual character in real time according to an embodiment of the present invention.

FIG. 3 is a flowchart of a method for dynamically generating response motions of a virtual character in real time according to an embodiment of the present invention.

FIG. 4 is a flowchart illustrating the detailed steps of calculating a balance state according to an embodiment of the present invention.

FIGS. 5A and 5B are schematic diagrams illustrating the calculation of a balance state according to an embodiment of the present invention.

FIGS. 6A and 6B illustrate a response graph according to an embodiment of the present invention.

FIG. 7 is a schematic diagram illustrating a character model driven toward a response motion according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention integrates the techniques of pre-recorded response and physical simulation so that the two can affect each other. The original monotonous pre-recorded response motions can be made livelier through physical simulation. On the other hand, the pre-recorded response motions in the present invention are mostly spontaneous motions of human beings instead of passive physical responses. Thus, lively responses can be presented when a virtual character interacts with the surroundings through these pre-recorded response motions.

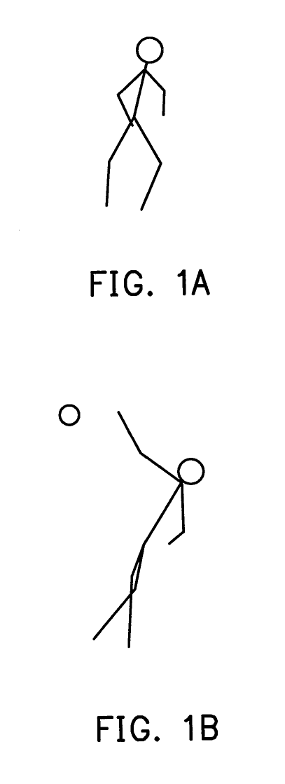

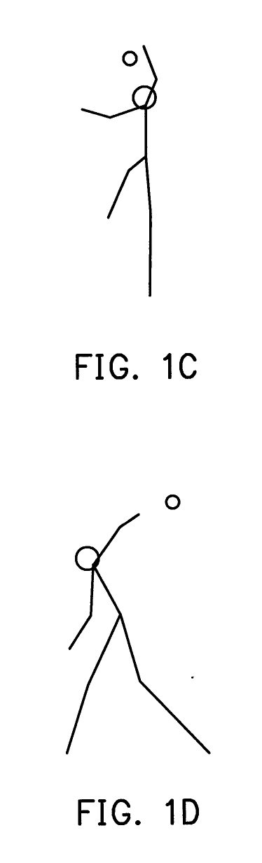

FIGS. 1A˜1D illustrate several pre-recorded motions of a virtual character according to an embodiment of the present invention. FIG. 1A illustrates a pre-recorded response motion stored in a database. This response motion shows that a virtual character is falling backwards, and during the falling process, the virtual character tries to gain its balance by waving its arms. This response motion is completely pre-recorded without any interference of physical simulation. Another two pre-recorded response motions showing that the character is falling leftwards and rightwards are also stored in the database. If physical simulation is applied, when the virtual character is hit by a ball and the impact produced is big enough to make the virtual character to fall, the system in the present embodiment calculates the direction in which the character will fall and reads the corresponding response motion from the database. Then the system integrates the response motion with physical effects such as gravity and the impact and plays the response motion in the image, as the falling response motions in three different directions illustrated in FIGS. 1B˜1D. Such a system can present smooth and lively response for a virtual character. In addition, it offers reduced requirement to memory space and lower fabrication cost compared to the technique of pre-recorded response and increased speed and reduced calculation resources compared to the technique of physical simulation.

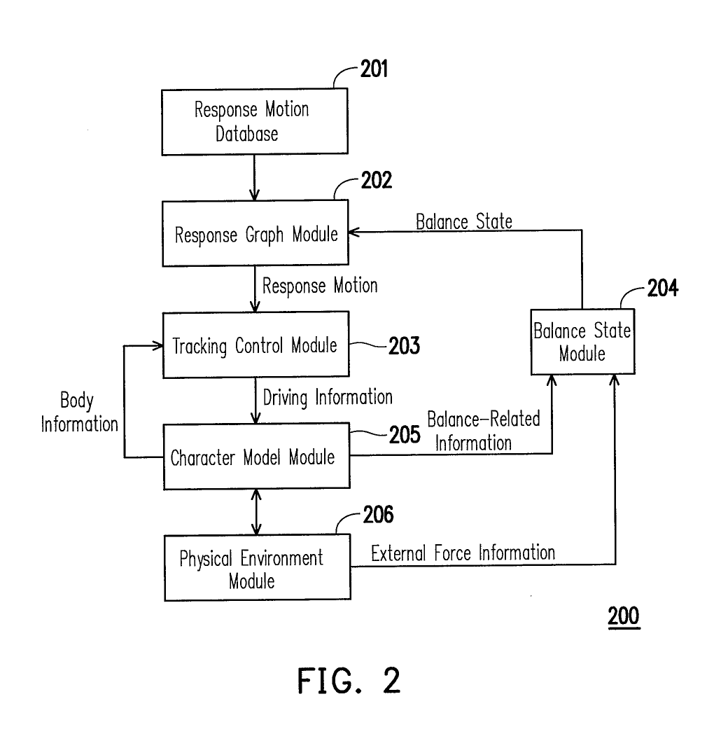

FIG. 2 is a block diagram of a system 200 for dynamically generating response motions of a virtual character in real time according to an embodiment of the present invention. The system 200 includes a response motion database 201, a response graph module 202, a tracking control module 203, a balance state module 204, a character model module 205, and a physical environment module 206. The response motion database 201 stores all the pre-recorded response motions. The balance state module 204 calculates a balance state of the virtual character according to the balance-related information of a character model of the virtual character and an external force information received from the physical environment module 206. The response graph module 202 is coupled to the balance state module 204 and the response motion database 201 for providing a response motion of the virtual character according to the balance state. The tracking control module 203 is coupled to the response graph module 202 for providing a driving information according to the response motion and the body information of the character model, wherein the driving information is used for driving the character model to converge toward the response motion. The character model module 205 is coupled to the balance state module 204 and the tracking control module 203, and the character model module 205 drives the character model according to the driving information and physical calculations, namely, the character model module 205 calculates motions of the virtual character through physical simulation. The character model module 205 provides the balance-related information to the balance state module 204 and provides the body information to the tracking control module 203. The physical environment module 206 is coupled to the balance state module 204 and the character model module 205. In the present embodiment, the physical environment module 206 provides the external force information to the balance state module 204.

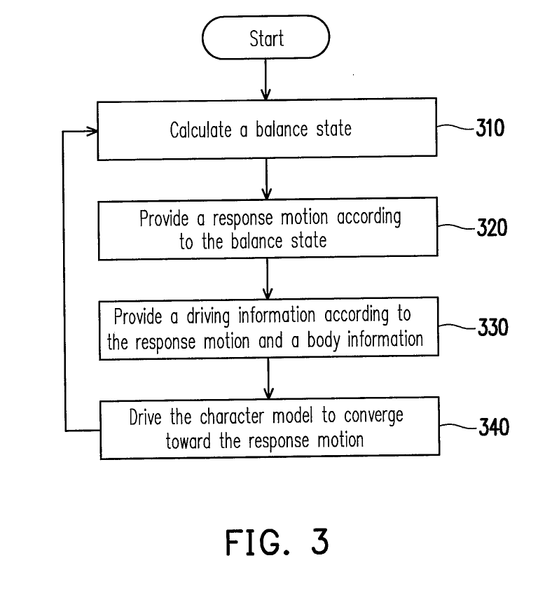

The present embodiment will be described in detail with reference to FIG. 3. FIG. 3 is a flowchart of a method for dynamically generating response motions of the virtual character in real time according to the present embodiment. The procedure illustrated in FIG. 3 is executed by the system 200. First, when the virtual character receives an external force, the balance state module 204 calculates the balance state of the virtual character according to the balance-related information and the external force information (step 310). The balance-related information is received from the character model and which may includes the mass, position, orientation, speed of each body segment of the character model or any combination of foregoing features. The external force information may include various forces received by the virtual character, such as an impact, the gravity, or the combination of the two.

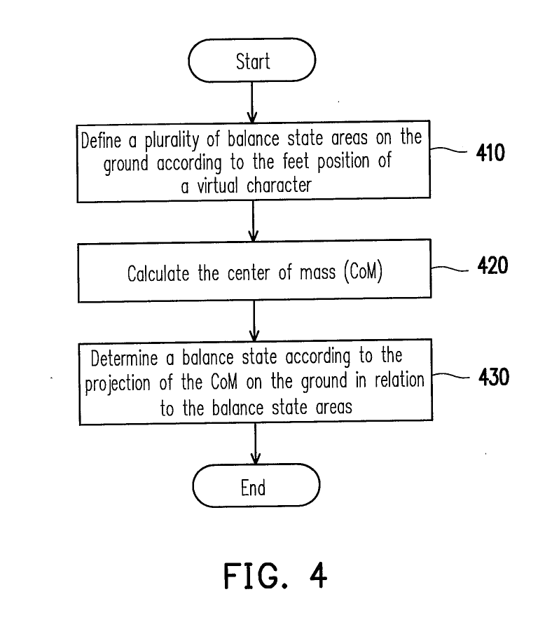

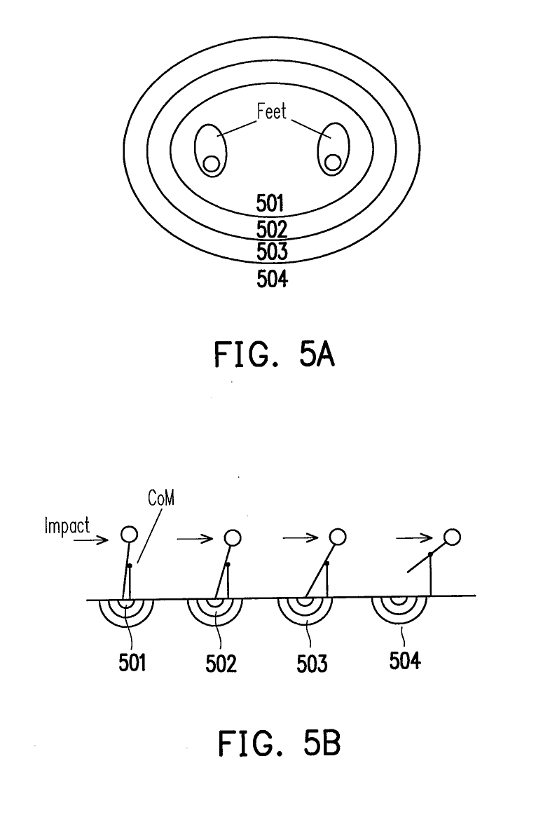

FIG. 4 is a flowchart illustrating a method for calculating the balance state in the present embodiment, namely, the detailed steps of step 310 in FIG. 3. FIGS. 5A and 5B are diagrams illustrating the method for calculating the balance state. First, a plurality of balance state areas is defined on the ground according to the feet positions of the character model (step 410). As shown in FIG. 5A, four balance state areas 501˜504 are defined.

Next, the position of the center of mass (CoM) of the character model is calculated according to the position of the character model in the space (step 420) with following expression, wherein N is the number of body segments of the character model, Mᵢ is the mass of the i^{th} body segment, and Pᵢ is the position of the i^{th} body segment.

$$CoM = {\sum }_{i = 0}^{N} {M}_{i} {P}_{i} / {\sum }_{i = 0}^{N} {M}_{i}$$

After that, the balance state of the virtual character after it receives the external force is determined according to the projection of the CoM on the ground in relation to the balance state areas (step 430). As shown in FIG. 5B, the projection of the CoM on the ground falls within the balance state areas 501˜504, wherein the further an area is away from the feet of the virtual character the more unbalanced the virtual character is.

FIG. 4 illustrates a simple method for calculating the balance state, and the balance state obtained through this method contains only the unbalanced degree of the virtual character. In the present embodiment, a more complicated method can be adopted for calculating the balance state. For example, the balance state can be calculated according to the orientation and the CoM of each body segment of the virtual character. The more complicated the method is, the more items the balance state contains. For example, the balance state may contain the pose, orientation, unbalanced degree, unbalanced direction, or the combination of foregoing items of the virtual character.

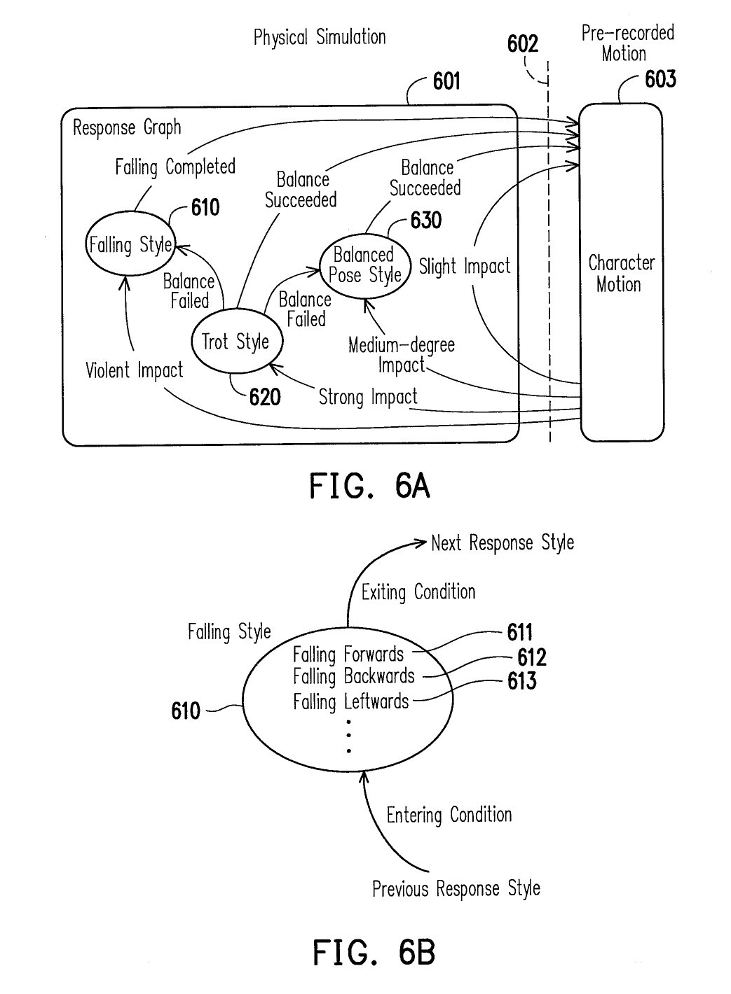

As shown in FIG. 3, after the balance state module 204 calculates the balance state of the virtual character, the response graph module 202 provides a response motion of the virtual character according to the balance state (step 320). As shown in FIGS. 6A and 6B, the response graph module 202 includes a state machine, and the state machine is corresponding to a response graph 601. The response graph 601 includes a plurality of response styles, for example, a falling style 610, a trot style 620, and a balanced pose style 630 as shown in the figures. Each of the response styles includes a plurality of response motions. For example, the falling style 610 includes a falling forwards response motion 611, a falling backwards response motion 612, and a falling leftwards response motion 613. Each response style of the response graph 601 is corresponding to one of a plurality of states of the state machine.

The response graph module 202 determines the response style of the virtual character according to the balance state and then selects one of the response motions of the response style according to the balance state and provides the selected response motion to the tracking control module 203. For example, the balance state may include unbalanced degree and unbalanced direction, and the response graph module 202 determines the response style in the response graph 601 according to the unbalanced degree and selects the response motion among the response motions of the response style according to the unbalanced direction.

The response styles illustrated in FIG. 6A will be described below, wherein each response style is entered or exited according to different unbalanced degrees, and the different unbalanced degrees are corresponding to different impact strengths of external forces. As shown in FIG. 6A, the virtual character is only slightly shifted by a slight impact and then resumes its original position. Such a procedure can be presented completely through physical simulation without the interference of any pre-recorded response motion. A medium-degree impact causes the virtual character to enter a balanced pose style 630, and here the response motion of the virtual character is to bring the CoM back by twisting its body and waving its arms. The virtual character leaves the balanced pose style 630 and returns to a pre-recorded character motion 603 after it gains its balance.

The virtual character enters the trot style 620 if it receives a strong impact, and here the response motion of the virtual character to back off so as to bring the CoM back. The virtual character returns to the pre-recorded character motion 603 once it gains balance. If the virtual character cannot gain its balance but the CoM has been brought back to a controllable range, the virtual character enters a balanced pose style 630 and brings the CoM back by twisting its body and waving its arms. If the virtual character cannot gain the balance and the CoM is still within a controllable range, the virtual character enters a falling style 610. One of the falling motions is selected and the virtual character returns to the pre-recorded character motion 603 after it falls. A violent impact causes the virtual character to directly enter the falling style 610. As to how to distinguish different degrees of impacts, a plurality of thresholds can be set according to a predetermined rule and the results of physical calculations are then categorized into different degrees of impacts or unbalanced degrees according to these thresholds.

The character motion 603 is completely a pre-recorded character motion but not aforementioned response motions, and which is not related to physical simulation. The character motion 603 may be a character motion controlled by the system, such as standing still, lying still, standing up from the ground, or a martial art position in a computer game.

Referring to FIG. 3 again, after the response graph module 202 provides the response motion, the tracking control module 203 provides a driving information according to the response motion received from the response graph module 202 and a body information received from the character model module 205, wherein the driving information is used for driving the character model (step 330). The body information includes the curving angle and angular velocity of each joint of the character model. The body information represents the current motion and pose of the virtual character, and the response motion represents the motion and pose to be presented next by the virtual character. The purpose of the tracking control module 203 is to make the motion of the character model to converge to the response motion.

The driving information provided by the tracking control module 203 may be the driving angular velocity ω of each joint of the character model, or may also be the driving moment τ of each joint of the character model. The driving information can be calculated according to the difference of joint angles and the difference of joint angular velocities between the response motion and the body information.

If driving angular velocity is used as the driving information, the formula of each joint is as following:

$$\begin{matrix}ω = α \frac{Δ θ}{Δ t} + β Δ \dot{θ} \\ = \frac{α}{Δ t} ( {θ}_{ref .} - {θ}_{sim .} ) + β ( {\dot{θ}}_{ref .} - {\dot{θ}}_{sim .} )\end{matrix}$$

Wherein α is a predetermined spring factor, β is a predetermined damp parameter, Δt is the unit time, Δθ is the difference of joint angles between the response motion and the body information, Δ\dot{θ} is the difference of joint angular velocities between the response motion and the body information. θ_{ref} and \dot{θ}_{ref} are respectively the angle and angular velocity of the response motion, and θₛᵢₘ and \dot{θ}ₛᵢₘ are respectively the angle and angular velocity of the body information.

If driving moment is used as the driving information, the formula of each joint is as following:

τ=α(θ_{ref.}−θ_{sim.})+β(\dot{θ}_{ref.}−\dot{θ}_{sim.})

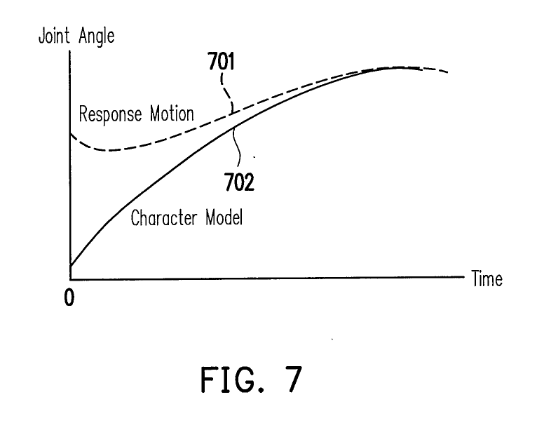

Referring to FIG. 3 again, after the tracking control module 203 provides the driving information, the character model module 205 drives the character model to converge toward the response motion according to the driving information (step 340), as illustrated by curves 701 and 702 in FIG. 7.

After step 340, the procedure illustrated in FIG. 3 returns to step 310 and the steps 310˜340 are repeated. This loop is repeated regarding each frame. In other words, the system 200 calculates the balance state of a first frame, selects the response motion, calculates the driving information, drives the character model to enter a second frame, calculates the balance state of the second frame, . . . , and so on. Because the loop is continuously repeated and change may occur during the courses of the response motions, the motion and response of the virtual character can be made very smooth and lively. For example, when the virtual character is hit by a ball in the front and then hit by another ball when it is falling backwards, the virtual character will become falling sideways.

In some embodiments of the present invention, the method illustrated in FIG. 3 can be executed by a computer program, and the computer program can be stored in any computer-readable recording medium, for example, a memory, a floppy disk, a hard disk, or an optical disk, etc.

In summary, according to the present invention, the physical responses to impacts to a virtual character are simulated through the method of physical simulation, and response motions of the virtual character are provided through the method of pre-recorded responses. In the present invention, the response motion of a virtual character is selected from a pre-established response graph according to the balance state of the virtual character. Thereby, the present invention has the advantages of both the method of pre-recorded response and the method of physical simulation and can present lively and smooth character motions conforming to physical effects. Moreover, in the present invention, real-time calculation can be achieved with less memory space.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for dynamically generating a response motion of a virtual character in real time, comprising:
a balance state module, calculating a balance state of the virtual character according to balance-related information of a character model of the virtual character;
a response graph module, coupled to the balance state module, the response graph module providing the response motion according to the balance state; and
a tracking control module, coupled to the response graph module, the tracking control module providing a driving information according to the response motion and body information of the character model, wherein the driving information is used for driving the character model to converge toward the response motion.

2. The system according to claim 1 further comprising:
a response motion database, coupled to the response graph module, the response motion database storing the response motion.

3. The system according to claim 1, wherein the balance-related information comprises at least one of the mass, position, orientation, and speed of each body segment of the character model.

4. The system according to claim 1, wherein the balance state module defines a plurality of balance state areas on a ground according to the feet positions of the character model, calculates the position of the center of mass (CoM) of the character model, and determines the balance state according to the projection of the CoM on the ground in relation to the balance state areas.

5. The system according to claim 1, wherein the balance state comprises at least one of the pose, the orientation, the unbalanced degree, and the unbalanced direction of the virtual character.

6. The system according to claim 1, wherein the response graph module comprises a state machine, the state machine is corresponding to a response graph, the response graph comprises a plurality of response styles, each of the response styles comprises a plurality of response motions and is corresponding to one of a plurality of states of the state machine, the response graph module determines the response style of the virtual character according to the balance state and selects one of the response motions of the response style according to the balance state and provides the selected response motion to the tracking control module.

7. The system according to claim 6, wherein the balance state comprises a first item and a second item, the response graph module determines the response style according to the first item and selects the response motion according to the second item.

8. The system according to claim 1, wherein the body information comprises the angle and angular velocity of each joint of the character model.

9. The system according to claim 1, wherein the tracking control module provides the driving information according to difference of joint angles and difference of joint angular velocities between the response motion and the body information.

10. The system according to claim 1, wherein the driving information comprises the driving angular velocity or driving moment of each joint of the character model.

11. The system according to claim 1 further comprising:
a character model module, coupled to the balance state module and the tracking control module, the character model module driving the character model according to the driving information and providing the balance-related information and the body information.

12. The system according to claim 1 further comprising:
a physical environment module, coupled to the balance state module, the physical environment module providing an external force information to the balance state module, wherein the balance state module calculates the balance state according to the balance-related information and the external force information.

13. The system according to claim 12, wherein the external force information comprises an impact and/or the gravity received by the virtual character.

14. A method for dynamically generating response motions of a virtual character in real time, comprising:
(a) calculating a balance state of the virtual character according to balance-related information of a character model of the virtual character;
(b) providing a response motion according to the balance state; and
(c) providing a driving information according to the response motion and body information of the character model, wherein the driving information is used for driving the character model to converge toward the response motion.

15. The method according to claim 14, wherein step (a) comprises:
defining a plurality of balance state areas on a ground according to the feet positions of the character model;
calculating the position of the CoM of the character model; and
determining the balance state according to the projection of the CoM on the ground in relation to the balance state areas.

16. The method according to claim 14, wherein step (b) comprises:
providing a state machine, the state machine being corresponding to a response graph, the response graph comprising a plurality of response styles, each of the response styles comprising a plurality of response motions and being corresponding to one of a plurality of states of the state machine;
determining the response style of the virtual character according to the balance state; and
selecting and providing one of the response motions of the response style according to the balance state.

17. The method according to claim 16, wherein the balance state comprises a first item and a second item, and the step (b) further comprises:
determining the response style according to the first item; and
selecting the response motion according to the second item.

18. The method according to claim 14, wherein the driving information is calculated according to difference of joint angles and difference of joint angular velocities between the response motion and the body information.

19. The method according to claim 14, wherein the balance state is calculated according to the balance-related information and an external force information.

20. A computer-readable recording medium, for storing a program, wherein the program executes a method for dynamically generating a response motion of a virtual character in real time, and the method comprises:
(a) calculating a balance state of the virtual character according to balance-related information of a character model of the virtual character;
(b) providing the response motion according to the balance state; and
(c) providing a driving information according to the response motion and body information of the character model, wherein the driving information is used for driving the character model to converge toward the response motion.

21. The computer-readable recording medium according to claim 20, wherein step (a) comprises:
defining a plurality of balance state areas on a ground according to the feet positions of the character model;
calculating the position of the CoM of the character model; and
determining the balance state according to the projection of the CoM on the ground in relation to the balance state areas.

22. The computer-readable recording medium according to claim 20, wherein step (b) comprises:
providing a state machine, the state machine being corresponding to a response graph, the response graph comprising a plurality of response styles, each of the response styles comprising a plurality of response motions and being corresponding to one of a plurality of states of the state machine;
determining the response style of the virtual character according to the balance state; and
selecting and providing one of the response motions of the response style according to the balance state.

23. The computer-readable recording medium according to claim 22, wherein the balance state comprises a first item and a second item, and step (b) further comprises:
determining the response style according to the first item; and
selecting the response motion according to the second item.

24. The computer-readable recording medium according to claim 20, wherein the driving information is calculated according to difference of joint angles and difference of joint angular velocities between the response motion and the body information.

25. The computer-readable recording medium according to claim 20, wherein the balance state is calculated according to the balance-related information and an external force information.
